(19) United States
(12) Patent Application Publication
(10) Pub. No.: US 2023/0239757 A1
(43) Pub. Date: Jul. 27, 2023

(54) METHOD AND APPARATUS FOR INTER-DONOR MOBILITY

(71) Applicant: ZTE Corporation, Shenzhen (CN)

(72) Inventors: Ying HUANG, Shenzhen (CN); Lin CHEN, Shenzhen (CN)

(73) Assignee: ZTE Corporation, Shenzhen (CN)

(21) Appl. No.: 18/174,402

(22) Filed: Feb. 24, 2023

Related U.S. Application Data
(63) Continuation of application No. PCT/CN2020/122834, filed on Oct. 22, 2020.

(51) Int. Cl. H04W 36/08; H04W 36/00

(52) U.S. Cl. CPC H04W 36/08; H04W 36/0055

(57) ABSTRACT

This disclosure relates to methods for inter-donor mobility. In one embodiment, a method includes migrating a wireless node from a source donor central unit (CU) to a target donor CU. In another embodiment, a method includes sending, by the source donor CU to the target donor CU, an XnAP mobility related request message requesting migration of the wireless node from the source donor CU to the target donor CU, and receiving, by the source donor CU from the target donor CU, an XnAP mobility related response message. In another embodiment, a method includes receiving, by a target donor CU from a source donor CU, an XnAP mobility related request message requesting migration of a wireless node from the source donor CU to the target donor CU, and sending, by the target donor CU to the source donor CU, an XnAP mobility related response message.

### TECHNICAL FIELD

This disclosure is directed generally to methods for inter-donor mobility and migration of a wireless node, particularly in an Integrated Access and Backhaul (IAB) network.

### BACKGROUND

As the number of applications and services for digital data continues to explode, the demands and challenges placed on network resources and operators will continue to increase. Being able to deliver a wide variety of network performance characteristics that future services will demand is one of the primary technical challenges faced by service providers today. The performance requirements placed on the network will demand connectivity in terms of data rate, latency, quality of service (QoS), security, availability, and many other parameters, all of which will vary from one service to the next. Thus, enabling a network to allocate resources in a flexible manner to provide customized connectivity for each different type of service will greatly enhance the network’s ability to meet future demands.

To meet these demands, the development of 5th Generation (5G) mobile wireless technologies and standards are well underway. One such technology is a split network architecture wherein the Radio Access Network (RAN) functionality is split between a Central Unit (CU) and multiple Distributed Units (DUs). For example, RAN functions may be split at the point between the Packet Data Convergence Protocol (PDCP) layer and the Radio Link Control (RLC) layer of the 5G protocol stack, wherein DUs will handle all processes up to and including the RLC layer functions and the CU will handle PDCP layer and higher layer functions prior to the core network. This disaggregation of RAN functions will provide numerous advantageous to mobile network operators. For example, through the isolation of the stack from the PDCP layer and upwards, the CU will be able to act as a Cloud-based convergence point among multiple heterogeneous technologies in the provisioned networks and hence will be able to serve multiple heterogeneous DUs.

Another technology being developed for 5G networks is an Integrated Access and Backhaul (IAB) architecture for providing high-speed wireless backhaul to cell sites (e.g., base stations). As data demands and the number of cell sites increase, it is becoming more difficult to provide traditional fiber optic backhaul access to each cell site, which is especially true for small cell base stations. Under the IAB architecture, the same infrastructure and resources (e.g., IAB nodes) can be used to provide both access and backhaul to support User Equipment (UE) Packet Data Unit (PDU) sessions, for example. The IAB architecture for New Radio (NR) networks will provide wireless backhaul and relay links enabling flexible and dense deployment of NR cells without the need for densifying the transport network proportionately. Additionally, IAB technologies will allow for easier deployment of a dense network of self-backhauled NR cells in a more integrated and robust manner. For example, the IAB technology in the 5G NR network will support a multi-hop relay system, where the network topology also supports redundant connections.

FIG. 1 illustrates a block diagram of an example IAB architecture network 100 wherein a core network 102 is connected to a donor IAB node 104 (also referred to as a “wireless node” herein), for example, via a wired or cabled connection (e.g., a fiber optic cable) between two nodes or devices. The terminating node of NR backhauling on network side is referred to as the IAB donor 104, which represents a gNB with additional functionality to support IAB. The IAB donor 104 is wirelessly coupled to a plurality of intermediate IAB nodes 106a and 106b and two serving IAB nodes 106c and 106d, which coupling may be direct or indirect and wired or wireless communications between two nodes or devices.

As shown in the example architecture of FIG. 1, serving IAB nodes 106c and 106d are directly coupled to UEs 108a and 108b, respectively, and function as the serving cell site base stations or access points for the UEs 108a and 108b. The serving IAB nodes 106c and 106d also function as relay and can forward their respective UE signals to their respective next uplink nodes in the transmission path, and forward downlink signals to their respective UEs 108a and 108b. As shown in FIG. 1, the serving IAB node 106c can forward uplink UE signals to one or both of the intermediate IAB nodes 106a and 106b, and receive downlink UE signals from one or both of the intermediate IAB nodes 106a and 106b. The intermediate IAB nodes 106a and 106b can forward uplink UE signals to the donor IAB node 104, and forward downlink signals to the serving IAB node 106d. The serving IAB node 106c can forward uplink UE signals to the donor IAB node 104, which can then forward all received signals to the core network 102, and can forward downlink signals from the donor IAB node 104 to the access UE 108a.

Each of the IAB nodes 106a-106d can have two functions: a base station (BS) function and a mobile terminal (MT) function. The BS function means the IAB node can work like a base station to provide the radio access function for a UE. The BS part of an IAB node refers to that portion of the IAB node, including all hardware, firmware and/or software related to performing the BS functions of the IAB node. The MT function means the IAB node can work like a mobile terminal to be controlled and scheduled by the IAB donor node or an upper IAB node. The MT part of an IAB node refers to that portion of the IAB node, including all hardware, firmware and/or software related to performing the MT functions of the IAB node.

Referring still to FIG. 1, if the network 100 also implements a split architecture, the donor IAB node 104 would be replaced by a donor CU connected to the core network 102 and a donor DU connected to the donor CU (see FIG. 3). Each of the IAB nodes 106a-106d would be coupled to the donor DU in similar fashion to their coupling to the donor IAB node 104, as shown in FIG. 1.

In a split architecture network, each of the IAB nodes 106a-106d can have two functions: a distributed unit (DU) function and a mobile terminal (MT) function. The DU function means the IAB node can work like a DU to provide the predetermined DU functions for a UE. The DU part of an IAB node refers to that portion of the IAB node, including all hardware, firmware and/or software related to performing the DU functions of the IAB node. The MT function and MT part of an IAB node in a split architecture network is the same as described above for a non-split architecture network.

All IAB-nodes that are connected to an IAB donor via one or multiple hops form a directed acyclic graph (DAG) topology with the IAB donor 104 at its root. In this DAG topology, the neighbor node on the IAB-DU’s interface is referred to as child node and the neighbor node on the IAB-MT’s interface is referred to as parent node. The direction toward the child node is further referred to as downstream while the direction toward the parent node is referred to as upstream. The IAB-donor performs centralized resource, topology, and route management for the IAB topology.

FIG. 2 shows the IAB user plane protocol stack between IAB-DU and IAB-donor-CU. The interface between a CU and DU (F1, where F1-U is the interface for user data, and F1-C is the interface for control data) uses an IP transport layer between IAB-DU and IAB-donor-CU. The IP layer may be further security-protected. On the wireless backhaul, the IP layer is carried over the BAP sublayer, which enables routing and bearer mapping over multiple hops. On each backhaul link, the BAP PDUs are carried by backhaul (BH) RLC channels. Multiple BH RLC channels can be configured on each BH link to allow traffic prioritization and QoS enforcement.

Such IAB networks support wireless backhauling via NR, which enables flexible and very dense deployment of NR cells while reducing the need for wireline transport infrastructure. Intra-donor CU migration procedures have been studied and specified, for example, in R16 IAB, in which both the source and the target parent node are served by the same IAB donor CU. However, there is not a solution for inter-donor CU migration scenarios, where the source donor CU is different from the target donor CU.

### SUMMARY

In one embodiment, a method includes migrating a wireless node from a source donor central unit (CU) to a target donor CU. In another embodiment, a method includes sending, by the source donor CU to the target donor CU, an XnAP mobility related request message requesting migration of the wireless node from the source donor CU to the target donor CU, and receiving, by the source donor CU from the target donor CU, an XnAP mobility related response message. In another embodiment, a method includes receiving, by a target donor CU from a source donor CU, an XnAP mobility related request message requesting migration of a wireless node from the source donor CU to the target donor CU, and sending, by the target donor CU to the source donor CU, an XnAP mobility related response message.

The above embodiments and other aspects and alternatives of their implementations are described in greater detail in the drawings, the descriptions, and the claims below.

### BRIEF DESCRIPTION OF THE DRAWINGS

FIG. 1 illustrates a block diagram of an example IAB architecture network according to various embodiments.

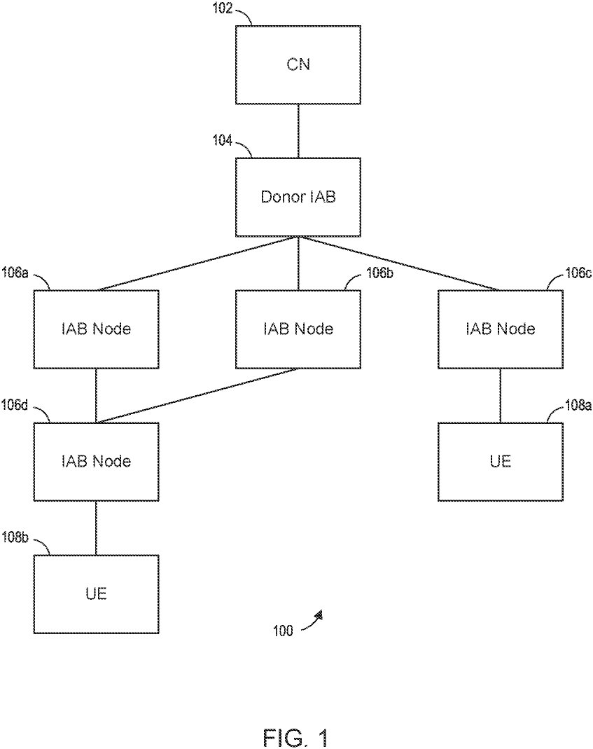

FIG. 2 illustrates an example user plane protocol stack according to various embodiments.

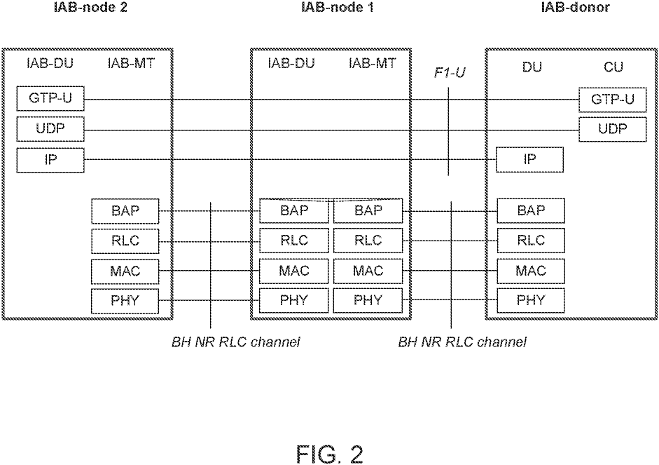

FIG. 3 illustrates another block diagram of an example IAB network in accordance with various embodiments.

FIG. 4 illustrates an example communication diagram in accordance with various embodiments.

FIG. 5 shows an example system diagram including a wireless node / UE and another wireless node according to various embodiments.

### DETAILED DESCRIPTION

The present inventors have developed methods and apparatus capable of performing inter-donor CU migration, where a wireless node (be it an IAB node or a UE) can migrate to a different transmission path, where the source parent node is served by a different donor CU than the target parent node.

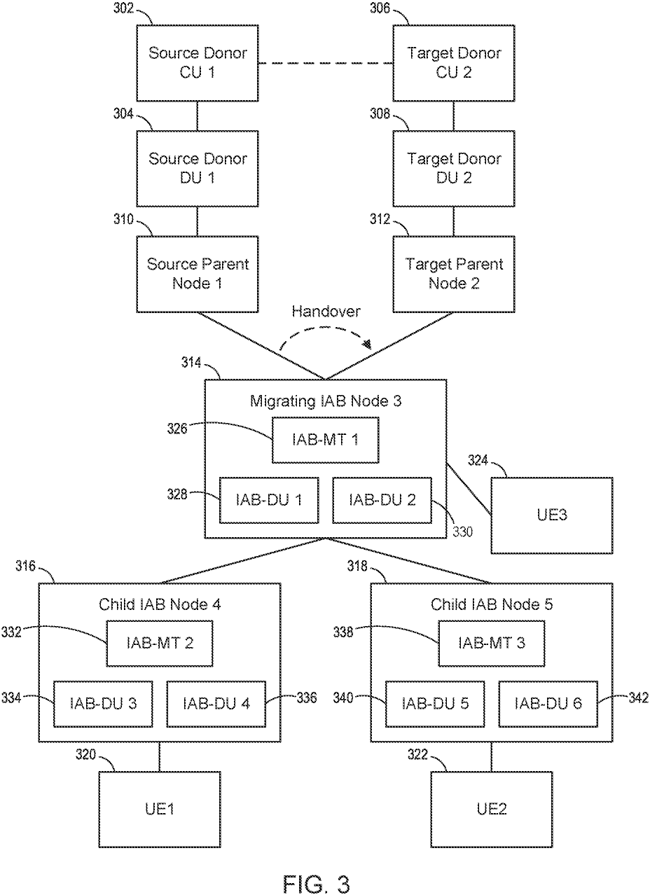

FIG. 3 illustrates a block diagram of an example IAB network in accordance with various embodiments, particularly illustrating an example handover scenario within the IAB network. FIG. 3 is referenced herein when describing the various methods and functions in the various embodiments. A source donor CU 302 and a source donor DU 304 are illustrated, which together form a source IAB donor. A target donor CU 306 and a target donor DU 308 are also illustrated, which together form a target IAB donor. A first source parent node 310 (e.g., a first parent wireless node) is connected to the source donor DU 304, and a second source parent node 312 (e.g., a first parent wireless node) is connected to the target donor DU 308. A wireless node 314, which may be a migrating IAB node, is shown as coupled (e.g., wirelessly) to the first source parent node 310 and the second source parent node 312. The wireless node 314 may be coupled to both the first source parent node 310 and the second source parent node 312 simultaneously or at different times. A first child node 316 and a second child node 318, which may each be a child IAB node) are connected to the wireless node 314. UE1 320 is shown as connected to the first child node 316, UE2 is shown as connected to the second child node 318, and UE3 324 is shown as connected to the wireless node 314.

As discussed above, the wireless node 314 may be split into an MT part, shown as IAB-MT 1 (326), and one or more DU parts, shown as IAB-DU 1 (328) and IAB-DU 1 (330). Similarly, the first child node 316 may likewise be split into an MT part, shown as IAB-MT 2 (332), and one or more DU parts, shown as IAB-DU 3 (334) and IAB-DU 4 (336). Likewise, the second child node 318 may be split into an MT part, shown as IAB-MT 3 (338), and one or more DU parts, shown as IAB-DU 5 (340) and IAB-DU 6 (342).

A handover procedure is generally illustrated with an arrow, wherein some or all of the connections and/or communication resources or channels shared between the source donor CU 302 and the wireless node 314 and/or its child nodes (e.g., first child node 316, second child node 318, UE1 320, UE2 322, and/or UE3 322) migrate to a different transmission path that instead includes the target donor CU 306.

In the example inter-donor CU migration scenario, the parent node, donor DU, and donor CU of the migrating wireless node (e.g., wireless node 314) are changed. Correspondingly, the donor DU and donor CU of the child nodes (e.g., nodes 316 and 318) and UEs (e.g., UEs 320, 322, and 324) served by migrating wireless node (e.g., wireless node 314) also need to be changed.

In certain approaches, the migration of the migrating IAB-MT (e.g., IAB-MT 1 (326)) of wireless node 314 involves a separate procedure with respect to the migration of the co-located IAB-DUs (e.g., IAB-DU 1 (328) and IAB-DU 2 (330)), the served UEs (e.g., UEs 320, 322, 324), and the served IAB-MTs (e.g., IAB-MT 2 (332) of the first child node 316 and/or IAB-MT 3 (338) of the second child node 318). In various examples, the migrating IAB-MT (e.g., IAB-MT 1 (326)) performs migration before the migration of child nodes 316 and 318 and UEs 320, 322, and 324. Migrating IAB-MT 1 (326) may disconnect from the source parent node 310 after receiving a radio resource control reconfiguration (RRCReconfiguration) message. Alternatively, migrating IAB-MT 1 (326) may still perform downlink reception from the source parent node 310, for example, using Dual Active Protocol Stack (DAPS).

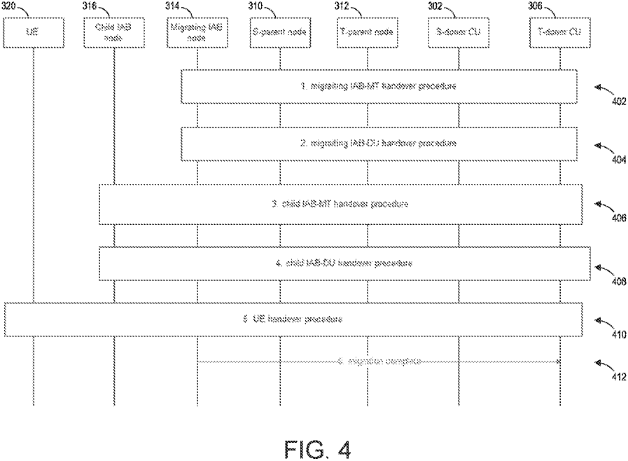

In accordance with various embodiments disclosed herein, a method of migrating a wireless node from a source donor CU 302 to a target donor CU 306 is disclosed. FIG. 4 is an example communication diagram illustrating some of the various migration steps and the nodes or entities involved (e.g., via communication) with each step.

In a first step of migration (402), the migrating IAB-MT’s (e.g., IAB-MT 1 (326)) handover procedure is performed. This handover procedure may be similar to a normal UE handover procedure. Source donor CU 302 sends an XnAP mobility related request message (e.g. a handover request message) to the target donor CU 306 requesting migration of the wireless node (e.g., the IAM-MT 1 (326) of wireless node 314) from the source donor CU 302 to the target donor CU 306. The XnAP mobility related request message may include at least one identity of one or more wireless nodes or UE that are to migrate from the source donor CU 302 to the target donor CU 306, which may include at least one of the following: one or more IAB-MT identities of IAB-MTs that are involved in the migration (e.g., IAB-MT 1 (326), IAB-MT 2 (332), and/or IAB-MT 3 (338)), and/or one or more UE identities of UEs that are involved in the migration (e.g., UEs 320, 322, 324). For example, the IAB-MT identity may be a Backhaul Adaptation Protocol (BAP) address of the IAB node allocated by source donor CU 302, or an XnAP ID allocated by source donor CU 302. The UE identity may be an XnAP ID allocated by source donor CU 302.

In response to receiving the XnAP mobility related request message from source donor CU 302, target donor CU 306 sends an XnAP mobility related response message (e.g. handover request ACK message) to source donor CU 302. The XnAP mobility related response message may include an RRCreconfiguration message for the IAB-MT 1 (326). The source donor CU 302 may then send the RRCreconfiguration message to the IAB-MT 1 (326) via the source path (e.g., through source donor DU 304 and the first source parent node 310). This RRCreconfiguration message then may cause the IAB-MT 1 (326) to connect to the target donor CU 306 (e.g., through the target parent node 312 and target donor DU 308), and, in some instances, possibly disconnect from the source donor CU 302.

In a second step of migration (404), the migrating IAB-DU’s (e.g., IAB-DU 1 (328) and/or IAB-DU 2 (330)) handover procedure is performed. Optionally, the migration of IAB-DU is initiated after the source donor CU 302 receives handover success message for the collocated IAB-MT (e.g., IAB-MT 1 (326)) from target donor CU 306. In various embodiments, the source donor CU 302 initiates migration of the migrating IAB-DU (e.g., IAB-DU 1 (328) and/or IAB-DU 2 (330)) by sending an XnAP mobility related request message (e.g. handover request message, which may be the same or a different XnAP message as discussed above for migration of the IAB-MT) to the target donor CU 306. The XnAP mobility related request message includes at least one of the following: a DU context, an identity of an IAB-MT (e.g., IAB-MT 1 (326)) collocated with the involved IAB-DU (e.g., IAB-DU 1 (328) and/or IAB-DU 2 (330). The identities may be a BAP address allocated by source donor CU 302 or an XnAP ID allocated by source donor CU 302. The migrating IAB-DU (e.g., IAB-DU 1 (328) and/or IAB-DU 2 (330) then needs to establish a connection (e.g., an F1 connection) with the target donor CU 306. This connection may be established via the source parent node 310 or the target parent node 312.

Accordingly, in the first two steps, an XnAP mobility related request message includes at least one identity of one or more MT parts (e.g., IAB-MT 1 (326)) or DU parts (e.g., IAB-DU 1 (328) and/or IAB-DU 2 (330)) of one or more wireless nodes (e.g., wireless node 314) that are to migrate from the source donor CU 302 to the target donor CU 306. This identity may include BAP address of the one or more wireless nodes allocated by the source donor CU, or an XnAP ID allocated by the source donor CU.

In various embodiments, after the wireless node 314 has been migrated, downstream nodes and UEs to wireless node 314 may begin to be migrated. In a third step of migration (406), which is similar to the first step (402), the child IAB-MT handover procedure is performed, which is similar to a normal UE handover procedure. Optionally, the child IAB-MT handover procedure (e.g., for the first or second child node 316 or 318) is initiated after source donor CU 302 receives a handover success message for the parent node of the child node (e.g., wireless node 314 in this example) from target donor CU 306. Source donor CU 302 sends an XnAP mobility related request message to the target donor CU 306, which includes at least one of the following: an identity of the involved IAB-MT (e.g., IAB-MT 2 (332) and/or IAB-MT 3 (338)) or an identity of the parent node of the involved IAB-MT (e.g., wireless node 314). For example, the identity may be a BAP address allocated by source donor CU or an XnAP ID allocated by source donor CU.

After receiving XnAP mobility related request message from source donor CU 302, the target donor CU 306 sends an XnAP mobility related response message (e.g. handover request ACK message) to source donor CU 302. The XnAP mobility related response message may include an RRCreconfiguration message for the child IAB-MT (e.g., IAB-MT 2 (332) and/or IAB-MT 3 (338)). The source donor CU 302 may send the RRCreconfiguration message to the child IAB-MT (e.g., IAB-MT 2 (332) and/or IAB-MT 3 (338)) via source path (i.e. via migrating wireless node’s 314 source parent node 310 and the source donor DU 314). Alternatively, the source donor CU 302 may send the RRCreconfiguration message to the child IAB-MT (e.g., IAB-MT 2 (332) and/or IAB-MT 3 (338)) via the target path (i.e. via migrating wireless node’s 314 target parent node 312, target DU 308, and target donor CU 306).

In a fourth step of migration (408), which is similar to the second step (404), the migration of child IAB-DU (e.g., any of IAB-DU 3-6 (334, 336, 340, and/or 342)) is performed. Optionally, the migration of a child IAB-DU is initiated after source donor CU 302 receives a handover success message for the collocated IAB-MT (e.g., IAB-MT 2 (332) and/or IAB-MT 3 (338)) from target donor CU 306. The source donor CU 302 initiates migration of child IAB-DUs by sending an XnAP mobility related request message (e.g. handover request message) to target donor CU 306. The XnAP mobility related request message includes at least one of the following: a DU context, an identity of an IAB-MT (e.g., IAB-MT 2 (332) and/or IAB-MT 3 (338)) collocated with the involved IAB-DU (e.g., any of IAB-DU 3-6 (334, 336, 340, and/or 342)). The identities may be a BAP address allocated by source donor CU 302 or an XnAP ID allocated by source donor CU 302. The child IAB-DU then needs to establish a connection (e.g., an F1 connection) with the target donor CU 306. This connection may be established via the source parent node 310 or the target parent node 312.

Accordingly, in steps three and/or four, an XnAP mobility related request message from the source donor CU 302 to the target donor CU 306 includes at least one of the following: at least one identity of one or more parent wireless nodes of the wireless node; at least one identity of one or more child wireless nodes or UE of the wireless node; at least one identity of one or more MT parts collocated with a DU parts of the wireless node; and/or at least one identity of one or more serving wireless nodes.

In a fifth step of migration (410), the UE handover procedure is performed. Optionally, the UE handover procedure is initiated after source donor CU 302 receives a handover success message for its serving wireless node (e.g., wireless node 314 for UE3 324, the first child node 316 for UE1 320, or the second child node 318 for UE2 322) from the target donor CU 306. The source donor CU 302 sends an XnAP mobility related request message (e.g. handover request message) to the target donor CU 306. The XnAP mobility related request message may include an identity of the involved UE and/or an identity of the serving wireless node. For example, the identity may be a BAP address allocated by source donor CU or an XnAP ID allocated by source donor CU.

Similar to after the third step (406), after receiving the XnAP mobility related request message from source donor CU 302, the target donor CU 306 sends XnAP mobility related response message (e.g. handover request ACK message) to the source donor CU 302. The XnAP mobility related response message includes an RRCreconfiguration message for the UE (e.g., 320, 322, and/or 324). The source donor CU 302 may send the RRCreconfiguration message to the UE via the source path (i.e. via migrating wireless node’s 314 source parent node 310 and the source donor DU 304). Alternatively, the source donor CU 302 may send the RRCreconfiguration message to the UE via the target path (i.e. via migrating wireless node’s 314 target parent node 312, target donor DU 308, and target donor CU 306).

In a sixth step of migration (412), optionally, the source donor CU 302 sends an XnAP message related message to target donor CU 306 to indicate that the migration from the source donor CU 302 to the target donor CU 306 is complete after the migration procedure of all the involved UEs and nodes has been initiated by source donor CU 302. In some examples, the mobility related message includes at least one of the following: an indication information indicating the migration of a mobile terminal (MT) part or a distributed unit (DU) part of the wireless node is complete; an indication information indicating the wireless node has established an F1 connection with the target donor CU; an indication information indicating F1-C between the wireless node and the target donor CU has migrated successfully; one or more new radio (NR) Cell Global Identifier (CGI)configured by the target donor CU; or one or more old NR CGI.

The sequence of the above steps is not restricted as is illustrated in FIG. 4. Instead, one or more steps may occur in parallel with each other. For example, the third, fourth, and fifth steps may be performed in parallel.

In the above embodiment, the various XnAP mobility related request messages (e.g., Handover request messages) the source donor CU 302 sends to the target donor CU 306 may include various information. For example, as sated above, it may include at least one identity of one or more wireless nodes or user equipment (UE) that are to migrate from the source donor CU 302 to the target donor CU 306. In some examples, the XnAP mobility related request messages may include (instead or in addition), gNB-DU System Information; gNB-DU Cell Resource Configuration configured by the source donor CU 302; Integrated access and backhaul (IAB) Synchronization Signal Block (SSB) Transmission Configuration (STC) Information configured by the source donor CU; Multiplexing Information of wireless node; and/or indication information that indicates migration of the wireless node from the source donor CU to the target donor CU is complete.

Additionally, in the above embodiment, the various XnAP mobility related response messages (e.g., Handover request ACK messages) the target donor CU 306 sends to the source donor CU 302 may include various information. For example, it may include a BAP address allocated by the target donor CU; an IP address allocated by the target donor CU or the target donor DU; traffic mapping information, including at least one of a Prior-Hop BAP Address, an Ingress backhaul (BH) Radio Link Control (RLC) Channel (CH) ID, a Next-Hop BAP Address, or an Egress BH RLC CH ID; a gNB DU Cell Resource Configuration configured by the target donor CU 306; IAB Synchronization Signal Block (SSB) Transmission Configuration (STC) Information configured by the target donor CU 306; one or more old BAP address of a child IAB node; one or more old BAP address of a parent IAB node; one or more new BAP address of the child IAB node configured by the target donor CU; or one or more new BAP address of the parent IAB node configured by the target donor CU. In some examples, the traffic mapping information is used for at least one of UL F1-C or non-F1 traffic mapping in the link between the wireless node and the target donor CU. Additionally or alternatively, it may also include at least one child DU cell configuration, comprising at least one of: an gNB-CU UE F1AP ID; a gNB-DU UE F1AP ID; an Cell Global Identifier (CGI); a gNB-DU Cell Resource Configuration; IAB STC Information; a Random Access Channel (RACH) configuration; a Channel State Information Reference Signal/Scheduling Request (CSI-RS/SR) Configuration; a Physical Downlink Control Channel (PDCCH) Configuration System Information Block 1 (SIB1); Subcarrier Spacing (SCS) Common; and/or Multiplexing Information. In various embodiments, this information in the XnAP mobility related response messages may be contained in an RRC message, which is included in the XnAP mobility related response messages. In such examples, the source donor CU may then transmit this information to the IAB node via RRC message.

In the following embodiments, methods are disclosed to enable the migrating wireless node (e.g., wireless node 314) to establish a connection (e.g., an F1 connection) with the target donor CU 306. In these embodiments, the wireless node 314 establishes an F1 connection with target donor CU 306 via the source path (i.e. via the source parent node 310 and source donor DU 304). These embodiments may be performed before the migrating wireless node 314 receives a RRC reconfiguration message to connect to the target donor CU 306. Alternatively, they could be performed at the same time or after the migrating wireless node 314 receives an RRC reconfiguration message (e.g. when DAPS is used).

In one embodiment, a solution of how to trigger a migrating wireless node 314 to establish a connection (e.g., an F1-C connection) with the target donor CU 306 via the source path is described. In one approach, the migration is triggered by the by wireless node 314 if a channel quality of a radio link of a serving cell is lower than a configured threshold. The source donor CU 302 may send threshold information (e.g. threshold for quality of the radio link for serving cell, threshold of quality of the radio link for neighbor cell) to the migrating wireless node 314, for example, via a Radio Resource Control (RRC) message. The wireless node 314 can then determine that a quality of the radio link (for the serving cell or neighbor cell) is below a threshold of the threshold information. As a result, the wireless node may trigger migration from the source donor CU 302 to the target donor CU 306 by, in part, establishing an F1 connection with the target donor CU 306.

In another approach, the migration is triggered by the source donor CU 302, for example, due to load balance issues. The source donor CU 302 may send to the wireless node 314 trigger information to trigger the wireless node 314 to migrate to the target donor CU 306, for example, by establishing an F1-C connection with target donor CU 306. The source donor CU 302 could send the trigger information via RRC or F1AP message. In response to receiving the trigger information from the source donor CU 302, the wireless node 314 can then migrate from the source donor CU 302 to the target donor CU 306 by, in part, establishing an F1 (e.g., and F1-C) connection with the target donor CU 306. The trigger information may include at least one of an F1 setup indication, an identity of the candidate donor CU, an identity of the target donor CU 306, or IP address information used to establish the F1 connection, wherein the identity of the target donor CU 306 may further comprise at least one of a gNB ID or a cell ID.

In another approach, the migration is triggered by a wireless node (e.g., wireless node 314) sending, to a second wireless node (e.g., first child node 316 and/or second child node 318) that is a child of the wireless node, trigger information to cause the second wireless node to migrate from the source donor CU 302 to the target donor CU 306. In various embodiments, the trigger information comprises at least one of an F1 setup indication, an identity of the candidate donor CU, an identity of the target donor CU 306, or IP address information used to establish the F1 connection with the target donor CU 306, wherein the identity of the target donor CU may further comprise at least one of a gNB ID or a cell ID. The wireless node 314 may send the trigger information via a BAP control Protocol Data Unit (PDU) or a Media Access Control (MAC) control PDU. In response to receiving the trigger information from the wireless node 314, the child node (e.g., first child node 316 and/or second child node 318) may then migrate from the source donor CU 302 to the target donor CU 306, in part, by establishing an F1 connection with the target donor CU 306.

Optionally, after receiving the trigger information from the wireless node 314, the child node may send trigger information to its child node or UE (e.g., UE1 320 and/or UE2 322) via BAP control PDU. For example, the child wireless node (e.g., first child node 316) may send to a third wireless node (e.g., UE1 320, or a different IAB node not shown) that is a child of the child wireless node, second trigger information to cause the third wireless node to migrate from the source donor CU 302 to the target donor CU 306. In response to receiving the second trigger information from the child wireless node, the third wireless node migrates from the source donor CU 302 to the target donor CU 306 by, at least in part, establishing an F1 connection with the target donor CU 306. This process may repeat downstream until all appropriate nodes and/or UE are migrated.

In another embodiment, a solution for providing a wireless node with the source and target IP addresses for the F1 connection with the target donor CU 306 is described. The wireless node (e.g., wireless node 314) may send to the source donor CU 302, a request for an IP address the wireless node 314 (i.e., for a new F1 connection with the target donor CU 306) and/or an IP address of the target donor CU 306. The wireless node 314 may send the request to the source donor CU 302 via a first Radio Resource Control (RRC) message. The request may include at least an identity of the target donor CU 306, such as a gNB ID or a cell ID of the target donor CU 306. Optionally, if the source donor CU 302 does not know the requested IP address(es), the source donor CU 302 may send to the target donor CU 306 a second request (e.g., via a first XnAP message) for the IP address of the wireless node 314 or the target donor CU 306. The source donor CU 302 may then receive from the target donor CU 306 (e.g., via a second XnAP message) the IP address(es) of the wireless node 314 or the target donor CU 306. The source donor CU 302 may then send to the wireless node 314 the IP address(es) of the wireless node 314 and/or the target donor CU 306, for example, via a second RRC message.

In another embodiment, a solution for transferring F1AP messages and/or Stream Control Transmission Protocol/Internet Protocol (SCTP/IP) packets between the migrating wireless node (e.g., wireless node 314) and the target donor CU 306 via the source path is described. In a first approach, F1-C messaging is effected using RRC messaging and XnAP messaging. First, the wireless node 314 sends to the source donor CU 302 a communication setup request message and, optionally, an identification of the target donor CU 306. The wireless node 314 may encapsulate the communication setup request message and, optionally, the identification of the target donor CU, in a first RRC message, and send the first RRC message to the source donor CU 302. In certain examples, the communication setup request message is an F1AP F1 setup request message or Stream Control Transmission Protocol/Internet Protocol (SCTP/IP) packets.

Second, the source donor CU 302 sends to the target donor CU 306 the communication setup request message. The source donor CU 302 may encapsulate the communication setup request message in a first XnAP message, and send the first XnAP message to the target donor CU 306. Optionally, if a non-UE associated XnAP message is used, the source donor CU 302 may also include an identity (e.g., BAP address or old DU ID) of the wireless node 314 in the first XnAP message.

Third, the target donor CU 306 sends, and the source donor CU 302 receives, a communication setup response message. The target donor CU 306 may encapsulate the communication setup response message in a second XnAP message and send the second XnAP message to the source donor CU 302, which receives the second XnAP message. In certain examples, the communication setup response message is an F1AP F1 setup response message or SCTP/IP packets. Again, optionally, if a non-UE associated XnAP message is used, the target donor CU 306 may also include an identity (e.g., BAP address or old DU ID) of the wireless node 314 in the second XnAP message.

Fourth, the source donor CU 302 sends the communication setup response message to the wireless node 314. The source donor CU 302 may encapsulate the communication setup response message (e.g., the F1AP F1 setup response message or SCTP/IP packets) in a second RRC message, and send the second RRC message to the wireless node 314.

In second approach, F1-C messaging is effected using F1AP messaging and XnAP messaging. This second approach is similar to the first approach, with slight differences. First, the wireless node 314 sends to the source donor CU 302 a communication setup request message and an identification of the target donor CU 306. More specifically, a DU part (e.g., IAB-DU 1 (328) or IAB-DU 2 (330)) of the wireless node 314 may send to the source donor CU 302 a first F1AP message including an F1 setup request message and, optionally, including first routing information. The routing information may include at least one of an identity (e.g. DU ID or BAP address) of the DU (e.g., IAB-DU 1 (328) or IAB-DU 2 (330)) of the wireless node 314 and/or an identity the target donor CU 306 (e.g., gNB ID).

Second, the source donor CU 302 sends to the target donor CU 306 the communication setup request message (e.g., the F1 setup request message and, optionally, the routing information). The source donor CU 302 may encapsulate the communication setup request message in a first XnAP message, and send the first XnAP message to the target donor CU 306. Optionally, if a non-UE associated XnAP message is used, the source donor CU 302 may also include an identity (e.g., BAP address or old DU ID) of the wireless node 314 in the first XnAP message.

Third, the target donor CU 306 sends, and the source donor CU 302 receives, a communication setup response message. The target donor CU 306 may encapsulate the communication setup response message in a second XnAP message and send the second XnAP message to the source donor CU 302, which receives the second XnAP message. In certain examples, the communication setup response message includes an F1AP F1 setup response message and, optionally, second routing information, which includes the identity (e.g. DU ID or BAP address) of the DU (e.g., IAB-DU 1 (328) or IAB-DU 2 (330)) of the wireless node 314 as a source ID and/or the identity the target donor CU 306 (e.g., gNB ID) as the target ID. Again, optionally, if a non-UE associated XnAP message is used, the target donor CU 306 may also include an identity (e.g., BAP address or old DU ID) of the wireless node 314 in the second XnAP message.

Fourth, the source donor CU 302 sends the communication setup response message and, optionally, the second routing information to the DU (e.g., IAB-DU 1 (328) or IAB-DU 2 (330)) of wireless node 314. The source donor CU 302 may send the communication setup response message in a second F1AP message including the F1 setup response message and, optionally, the second routing information.

In another embodiment, a solution for delivering child nodes and/or UE RRC reconfiguration message via the target path is disclosed. In this embodiment, the MT (e.g., IAB-MT1 (326)) of the wireless node 314 performs migration before the children nodes (e.g., first child node 316 and/or second child node 318) and UEs (e.g., UEs 320, 322, 324) perform their migration. Further, IAB-MT1 (326) may disconnect from the source parent node 310 (and the source donor CU 302) after handover. Accordingly, any RRC reconfiguration messages for the children IAB-MTs and UEs are delivered via the new target path.

In this embodiment, F1-C messaging is effected via XnAP messaging and either RRC messaging (similar to the first approach discussed in the previous embodiment) or F1AP messaging (similar to the second approach discussed in the previous embodiment). In a first step (as discussed above), the source donor CU 302 sends a first XnAP mobility related request message (e.g. handover request message) to target donor CU, which indicates that an IAB-MT (e.g., IAB-MT2 (332)) of child node (e.g., child node 316) is to migrate to the target donor CU 306. In a second step, the target donor CU 306 sends an XnAP mobility related response message (e.g. handover request ACK message) to the source donor CU 302. The XnAP mobility related response message includes an RRCreconfiguration message for the IAB-MT (e.g., IAB-MT2 (332)) of child node (e.g., child node 316).

In a third step, the source donor CU 302 sends a second XnAP message to the target donor CU 306. The second XnAP message includes a first F1AP message encapsulated in the second XnAP message, and the first F1AP message encapsulates the RRCreconfiguration message for the IAB-MT (e.g., IAB-MT2 (332)) received from the target donor CU 306. In a fourth step, the target donor CU 306 encapsulates the first F1AP message (received from the source donor CU 302 in the second XnAP message) in a third message, and sends the third message to the wireless node (e.g., wireless node 314).

In a first approach, the third message is an RRC message encapsulating the first F1AP message (which in turn encapsulates the RRCreconfiguration message for the IAB-MT (e.g., IAB-MT2 (332)). The target donor CU 306 sends the RRC message to the MT (e.g., IAB-MT1 (326)) of the wireless node 314. Then, the MT (e.g., IAB-MT1 (326)) delivers the first F1AP message received in the RRC message to the co-located DU (e.g., IAB-DU1 (328)) of the wireless node 314. The RRCreconfiguration message for IAB-MT2 (332) of the first child node 316 is contained in the first F1AP message. The first wireless node 314 then sends to the first child node 316 the RRCreconfiguration message. More specifically, the IAB-DU1 328 sends the RRCreconfiguration message to IAB-MT2 (332) of the first child node 316.

In a second approach, the third message is instead a second F1AP message encapsulating the first F1AP message (which in turn encapsulates the RRCreconfiguration message for the IAB-MT (e.g., IAB-MT2 (332)). The target donor CU 306 sends the second F1AP message to the DU (e.g., IAB-DU2 (330)) of the wireless node 314. In an instance where a wireless node 314 includes two DUs, e.g., a source logical DU (e.g., IAB-DU1 (328)) and a target logical DU (e.g., IAB-DU2 (330)), optionally, the second F1AP message also includes the DU ID of the source logical DU (e.g., IAB-DU1 (328)). Then, the DU (e.g., IAB-DU2 (330)) delivers the first F1AP message received in the second F1AP message to the co-located DU (e.g., IAB-DU1 (328)) of the wireless node 314. The RRCreconfiguration message for IAB-MT2 (332) of the first child node 316 is contained in the first F1AP message. The first wireless node 314 then sends to the first child node 316 the RRCreconfiguration message. More specifically, the IAB-DU1 328 sends the RRCreconfiguration message to IAB-MT2 (332) of the first child node 316.

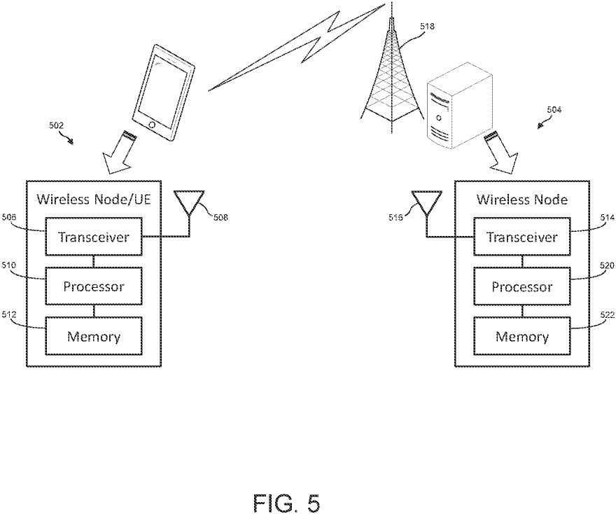

FIG. 5 shows an example system diagram including an example wireless node / UE 502 and a wireless node 504 with a wireless access network according to various embodiments. The wireless access network provides network connectivity between wireless nodes and/or user equipment (UE) devices and an information or data network (such as a voice communication network or the Internet). An example wireless access network may be based on cellular technologies, which may further be based on, for example, 4G, Long Term Evolution (LTE), 5G, New Radio (NR), and/or New Radio Unlicensed (NR-U) technologies and/or formats. The wireless node / UE 502 may comprise a UE, which may further include but is not limited to a mobile phone, smart phone, tablet, laptop computer, or other mobile devices that are capable of communicating wirelessly over a network. Alternatively, the wireless node / UE 502 may comprise a wireless relaying node such as an IAB-node. When acting as a relaying node, the wireless node / UE 502 may serve as an intermediary wireless node between an upstream wireless access point and a downstream UE and/or another downstream relaying node (such as another IAB-node). The wireless node / UE 502 may include transceiver circuitry 506 coupled to an antenna 508 to effect wireless communication with the wireless node 504 upstream, and/or other wireless nodes or UE downstream. The transceiver circuitry 506 may also be coupled to a processor 510, which may also be coupled to a memory 512 or other storage device. The memory 512 may store therein instructions or code that, when read and executed by the processor 510, cause the processor 510 to implement various ones of the methods described herein.

Similarly, the wireless node 504 may comprise a base station or other wireless network access points capable of communicating wirelessly over a network with one or many other wireless nodes and/or UEs. For example, the wireless node 504 may comprise a 4G LTE base station, a 5G NR base station, a 5G central-unit base station, a 5G distributed-unit base station, or a next generation Node B (gNB), an enhanced Node B (eNB), or other base station, in various embodiments. Alternatively, as discussed above, wireless node 504 may also comprise a wireless relaying node (such as another IAB-node or an IAB-donor), which may in turn communicate with a wireless access point further upstream. The wireless node 504 may include transceiver circuitry 514 coupled to an antenna 516, which may include an antenna tower 518 in various approaches, to effect wireless communication with the wireless node / UE 502. The transceiver circuitry 514 may also be coupled to one or more processors 520, which may also be coupled to a memory 522 or other storage device. The memory 522 may store therein instructions or code that, when read and executed by the processor 520, cause the processor 520 to implement various ones of the methods described herein.

The wireless access network may provide or employ various transmission formats and protocols for wireless message transmission between the wireless node / UE 502 and the wireless node 504, and between other wireless nodes and UE within the network.

In various embodiments, as illustrated in FIG. 5, the wireless node / UE 502 includes a processor 510 and a memory 512, wherein the processor 510 is configured to read computer code from the memory 512 to implement any of the methods and embodiments disclosed above relating to operations of the wireless node / UE 502. Similarly, the wireless node 504 includes a processor 520 and a memory 522, wherein the processor 520 is configured to read computer code from the memory 522 to implement any of the methods and embodiments disclosed above relating to operations of the wireless node 504. Also, in various embodiments, a computer program product includes a non-transitory computer-readable program medium (e.g., memory 512 or 522) with computer code stored thereupon. The computer code, when executed by a processor (e.g., processor 510 or 520), causes the processor to implement a method corresponding to any of the embodiments disclosed above. Similarly, as illustrated in FIGS. 3 and 5, a communication system includes the wireless node (e.g., wireless node 314), the source donor CU 302, and the target donor CU 306, and optionally, a second wireless node (e.g., child node 316). Each of the wireless node, the source donor CU 302, the target donor CU 306, and second wireless node comprises a processor (e.g., processors 510 or 520) and a memory (e.g., memory 512 or 522). The processors of the wireless node, the source donor CU, the target donor CU, and the second wireless node are configured to read computer code from the respective memories of the wireless node, the source donor CU, the target donor CU, and the second wireless node to implement a method corresponding to any of the embodiments disclosed above.

In accordance with the various methods and embodiments disclosed above, various technical advantages are realized. Primarily, inter-donor CU migration is possible, thereby allowing additional flexibility when migrating wireless nodes and/or UE amongst different backhaul transmission paths.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method comprising:
sending, by a source donor central unit (CU) to a target donor CU, an XnAP mobility related request message requesting migration of a wireless node from the source donor CU to the target donor CU; and
receiving, by the source donor CU from the target donor CU, an XnAP mobility related response message in response to sending the XnAP mobility related request message.

2. The method according to claim 1, wherein the XnAP mobility related request message comprises at least one of the following:
at least one identity of one or more wireless nodes or user equipment (UE) that are to migrate from the source donor CU to the target donor CU;
gNB-DU System Information;
gNB-DU Cell Resource Configuration configured by the source donor CU;
Integrated access and backhaul (IAB) Synchronization Signal Block (SSB) Transmission Configuration (STC) Information configured by the source donor CU;
Multiplexing Information of wireless node; or
indication information that indicates migration of the wireless node from the source donor CU to the target donor CU is complete.

3. The method according to claim 1, wherein the XnAP mobility related request message comprises at least one identity of one or more mobile terminal (MT) parts or distributed unit (DU) parts of one or more wireless nodes that are to migrate from the source donor CU to the target donor CU, wherein the at least one identity further comprises at least one of a Backhaul Adaptation Protocol (BAP) address of the one or more wireless nodes allocated by the source donor CU, or an XnAP ID allocated by the source donor CU.

4. The method according to claim 1, wherein the XnAP mobility related request message comprises at least one of the following:
at least one identity of one or more parent wireless nodes of the wireless node;
at least one identity of one or more child wireless nodes or UE of the wireless node;
at least one identity of one or more mobile terminal (MT) parts collocated with a distributed unit (DU) parts of the wireless node; or
at least one identity of one or more serving wireless nodes.

5. The method according to claim 1, further comprising:
sending, by the source donor CU to the target donor CU, a mobility related message indicating that migration of the wireless node from the source donor CU to the target donor CU is complete.

6. The method according to claim 1, further comprising:
receiving, by the source donor CU from the target donor CU, a mobility related message including at least one of the following:
an indication information indicating the migration of a mobile terminal (MT) part or a distributed unit (DU) part of the wireless node is complete;
an indication information indicating the wireless node has established an F1 connection with the target donor CU;
an indication information indicating F1-C between the wireless node and the target donor CU has migrated successfully;
one or more new radio (NR) Cell Global Identifier (CGI) configured by the target donor CU; or
one or more old NR CGI.

7. The method according to claim 1, wherein the XnAP mobility related response message comprises at least one of the following:
a BAP address allocated by the target donor CU;
an IP address allocated by the target donor CU or the target donor DU;
traffic mapping information, including at least one of a Prior-Hop Backhaul Adaptation Protocol (BAP) Address, an Ingress backhaul (BH) Radio Link Control (RLC) Channel (CH) ID, a Next-Hop BAP Address, or an Egress BH RLC CH ID;
a gNB distributed unit (DU) Cell Resource Configuration configured by the target donor CU;
Integrated access and backhaul (IAB) Synchronization Signal Block (SSB) Transmission Configuration (STC) Information configured by the target donor CU;
one or more old BAP address of a child IAB node;
one or more old BAP address of a parent IAB node;
one or more new BAP address of the child IAB node configured by the target donor CU; or
one or more new BAP address of the parent IAB node configured by the target donor CU.

8. (canceled)

9. The method according to claim 1, wherein the XnAP mobility related response message further comprises at least one child distributed unit (DU) cell configuration, comprising at least one of:
an gNB-CU UE F1AP ID;
a gNB-DU UE F1AP ID;
an old Cell Global Identifier (CGI);
a gNB-DU Cell Resource Configuration;
IAB STC Information;
a Random Access Channel (RACH) configuration;
a Channel State Information Reference Signal/Scheduling Request (CSI-RS/SR) Configuration;
a Physical Downlink Control Channel (PDCCH) Configuration System Information Block 1 (SIB1);
Subcarrier Spacing (SCS) Common; or
Multiplexing Information.

10. The method according to claim 1, further comprising:
sending, by the source donor CU to the wireless node, a threshold information.

11. The method according to 10, further comprising:
sending, by the source donor CU to the wireless node, the threshold information via a Radio Resource Control (RRC) message.

12. The method according to claim 1, further comprising:
sending, by the source donor CU to the wireless node, trigger information to trigger the wireless node to migrate to the target donor CU.

13. (canceled)

14. The method according to claim 1, further comprising:
receiving, by the source donor CU from the wireless node, a request for an Internet Protocol (IP) address of at least one of the wireless node or the target donor CU; and
sending, by the source donor CU to the wireless node, the IP address of the at least one of the wireless node or the target donor CU in response to receiving the request for the IP address.

15. (canceled)

16. (canceled)

17. (canceled)

18. (canceled)

19. (canceled)

20. The method according to claim 1, further comprising:
receiving, by the source donor CU from the wireless node, a communication setup request message; and
sending, by the source donor CU to the wireless node, a communication setup response message.

21. (canceled)

22. (canceled)

23. (canceled)

24. (canceled)

25. (canceled)

26. The method according to claim 1, further comprising:
sending, by the source donor CU to the target donor CU, a communication setup request message; and
receiving, by the source donor CU from the target donor CU, a communication setup response message.

27. (canceled)

28. (canceled)

29. (canceled)

30. (canceled)

31. (canceled)

32. The method according to claim 1, further comprising:
sending, by the source donor CU to the target donor CU, a second XnAP message comprising a first F1AP message encapsulated in the second XnAP message, wherein an RRCreconfiguration message is encapsulated in the first F1AP message.

33. A method comprising:
receiving, by a target donor central unit (CU) from a source donor CU, an XnAP mobility related request message requesting migration of a wireless node from the source donor CU to the target donor CU; and
sending, by the target donor CU to the source donor CU, an XnAP mobility related response message in response to receiving the XnAP mobility related request message.

34. The method according to claim 33, wherein the XnAP mobility related request message comprises at least one of the following:
at least one identity of one or more wireless nodes or user equipment (UE) that are to migrate from the source donor CU to the target donor CU;
gNB-DU System Information;
gNB-DU Cell Resource Configuration configured by the source donor CU;
Integrated access and backhaul (IAB) Synchronization Signal Block (SSB) Transmission Configuration (STC) Information configured by the source donor CU;
Multiplexing Information of wireless node; or
indication information that indicates migration of the wireless node from the source donor CU to the target donor CU is complete.

35. (canceled)

36. (canceled)

37. (canceled)

38. (canceled)

39. (canceled)

40. (canceled)

41. (canceled)

42. (canceled)

43. (canceled)

44. The method according to claim 33, further comprising:
receiving, by the target donor CU from the source donor CU, a communication setup request message; and
sending, by the target donor CU to the source donor CU, a communication setup response message.

45. (canceled)

46. (canceled)

47. (canceled)

48. (canceled)

49. (canceled)

50. The method according to claim 33, further comprising:
receiving, by the target donor CU from the source donor CU, a second XnAP message comprising a first F1AP message encapsulated in the second XnAP message, wherein an RRCreconfiguration message is encapsulated in the first F1AP message;
encapsulating, by the target donor CU, the first F1AP message in a first message; and
sending, by the target donor CU to the first wireless node, the first message.

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. A source donor central unit comprising:
a processor; and
a non-transient memory in communication with the processor, the memory storing a plurality of instructions that, when executed by the processor, configure the processor to:
send to a target donor CU, an XnAP mobility related request message requesting migration of a wireless node from the source donor CU to the target donor CU; and
receive from the target donor CU, an XnAP mobility related response message in response to sending the XnAP mobility related request message.
